(19) United States
(12) Patent Application Publication
(10) Pub. No.: US 2010/0215319 A1
(43) Pub. Date: Aug. 26, 2010

(54) Multi-Fiber Ferrule with Integrated, Molded Guide Pin

(76) Inventors: Darrell R. Childers, Hickory, NC (US); Joseph P. Howard, Hickory, NC (US); Joseph L. Kaminski, Hickory, NC (US); Dirk E. Schoellner, Hickory, NC (US); Russell J. Granger, Vale, NC (US); DJ Hastings, Crouse, NC (US)

Correspondence Address: Michael L. Leetzow, P.A., 2393 Crest Ridge Ct, SANFORD, FL, 32771, US

(21) Appl. No.: 12/607,050

(22) Filed: Oct. 27, 2009

Related U.S. Application Data
(60) Provisional application No. 61/109,145, filed on Oct. 28, 2008.

(51) Int. Cl. G02B 6/38

(52) U.S. Cl. 385/60

(57) ABSTRACT

A multi-fiber ferrule has openings for optical fibers, an integral fiber optic guide pin and an opening to receive a fiber optic guide pin. A plate is provided to align the optical fibers with the front face of the multi-fiber ferrule. A method for aligning the optical fibers with the front face of the multi-fiber ferrule is also provided.

### REFERENCE TO RELATED CASE

This application claims priority under 35 U.S.C. §119 (e) to provisional application No. 61/109,145, filed on Oct. 28, 2008, which is hereby incorporated by reference in its entirety.

### BACKGROUND OF THE INVENTION

### Field of the Invention

Typically, MT ferrules are molded with 2 guide holes in each ferrule. During the manufacturing process, metal guide pins attached to a guide pin clamp are added to 1 connector (male MT) and the mating ferrule is left with holes (female MT). Occasionally, the male/female configuration of connectors causes confusion and requires connectors to be reworked and changed from male to female or vice versa. The metal pins and pin clamp also add additional cost to the assembly.

In the past, it has not been possible to mold the pin into the ferrule because the ferrule must be polished after installing the fibers into the ferrule. The polishing process creates a near planar surface on the end face of the completed ferrule with no protruding features.

### SUMMARY OF THE INVENTION

The present invention is for a multi-fiber ferrule that consists of one molded guide pin and one molded guide hole. It is possible to allow for a molded guide pin protruding from the end face surface because the typical polishing process is replaced with a process that accurately locates the array of fibers at the end face of the ferrule and then epoxies them in place. The accuracy of the fibers is better than 20 microns coplanarity. This accuracy is sufficient for a reasonable insertion loss (<1 dB), even though is does not achieve physical contact of the fiber tips consistently.

According to one aspect of the present invention, a multi-fiber ferrule is provided that includes a main body having a front face and a middle portion, a plurality of openings extending between the front face and the middle portion of the main body to receive optical fibers therein, a fiber optic guide pin integrally formed with the main body and extending outwardly from the front face, and a fiber optic guide pin opening extending through the front face and rearwardly to receive a corresponding fiber optic guide pin.

In yet another aspect, a method of inserting optical fibers into a multi-fiber ferrule, the multi-fiber ferrule including a main body having a front face and a middle portion, a plurality of openings extending between the front face and the middle portion of the main body to receive optical fibers therein, a fiber optic guide pin integrally formed with the main body and extending outwardly from the front face, and a fiber optic guide pin opening extending through the front face and rearwardly to receive a corresponding fiber optic guide pin, the method includes providing a plate having a front face, a fiber optic guide pin extending outwardly from the front face away from the plate, a fiber optic guide pin opening extending from the front face towards the plate and a recessed portion between the fiber optic guide pin and the fiber optic guide pin opening, aligning the multi-fiber ferrule with plate such that the fiber optic guide pin from the multi-fiber ferrule engages the fiber optic guide pin opening in the plate, inserting an optical fiber in each of the plurality of openings in the multi-fiber ferrule, pushing the optical fibers toward the plate until ends of the optical fibers touch the plate, and securing the optical fibers in the multi-fiber ferrule.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a perspective view of one embodiment of a multi-fiber ferrule according to the present invention;

FIG. 2 is a perspective view of one embodiment of a plate used with the multi-fiber ferrule of FIG. 1 according to the present invention;

FIG. 3 is a top view of the multi-fiber ferrule of FIG. 1 and fiber optic ribbon inserted therein engaging the plate of FIG. 3 to appropriately place the optical fibers in the fiber optic ribbon with regard to the molded guide pin and end face of the multi-fiber ferrule; and

FIG. 4 is a cross-sectional view of the multi-fiber ferrule and plate of FIG. 3.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

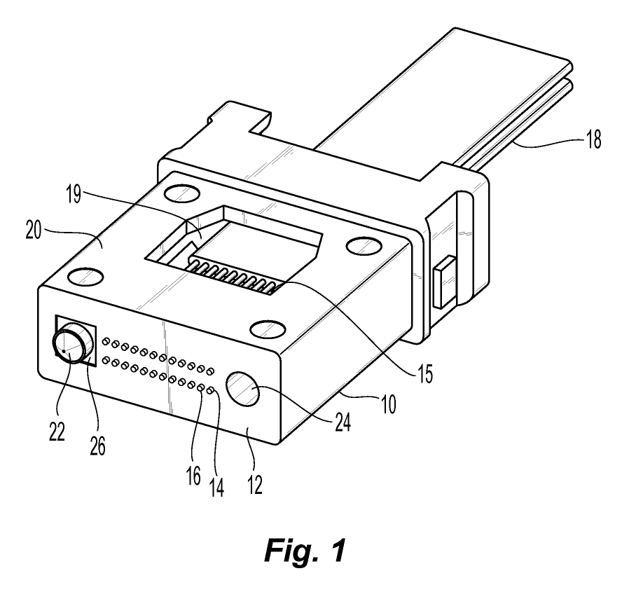

Referring to FIG. 1, a multi-fiber ferrule 10 according to the present invention is illustrated. The multi-fiber ferrule 10 preferably has an end face 12 with micro-holes 14 extending therethrough from a middle portion 15 to hold optical fibers 16 from the optical fiber ribbons 18. While 24 micro-holes 14 are illustrated, any number may be present (i.e., 12, 24, 48, etc.) and fall within the scope of the present invention. The multi-fiber ferrule 10 preferably has an opening 19 on one side 20 to allow for the application of epoxy to secure the optical fibers 16 (and the optical fiber ribbon 18) in the multi-fiber ferrule 10. The end face 12 also preferably includes a molded guide pin 22 and one molded opening 24, which corresponds to the fiber optic guide pin openings in prior art ferrules. By using one molded guide pin 22 and one molded opening 24, making it a hermaphroditic ferrule, only one hermaphroditic ferrule type needs to be manufactured and still allow for mating with the other hermaphroditic ferrules. The molded guide pin 22 preferably has a recessed area 26 at the base of the molded guide pin 22 to allow a radius to be molded at the base of the molded guide pin 22 and still allow two multi-fiber ferrules 10 to mate flush to each other. If there were no recessed area 26 and a radius was molded at the base of the molded guide pin, the radius would prevent face-to-face fating of the multi-fiber ferrules 10. By using a hermaphroditic ferrule, fiber optic connectors using the multi-fiber ferrules 10 are mated key-up to key-up instead of the typical key-up to key-down configuration. By molding the guide pin 22, fewer parts are needed in the assembly, since there is no need for the female pin clamp, the male pin clamp, or the metal guide pins.

It should also be noted that since the multi-fiber ferrule 10 is not polished during processing, the multi-fiber ferrule 10 can be made of a lower cost resin that does not control the distribution of glass beads and does not require deflashing Additionally, the multi-fiber ferrules 10 are preferably made from a translucent material that has a base polymer of polyetherimide. Other clear or translucent polymers would also be possible such as cyclo-olefin copolymer or polyphenylsulfone. As noted below, a translucent material allows for the use of a light-curable epoxy with the multi-fiber ferrules 10. Additionally, the material also preferably has a lower modulus than with other ferrules. In the present invention, material that has a modulus of 5 GPa rather than the typical 18 GPa is preferably used. This material allows for a better mating of the multi-fiber ferrules because it allows contact of the front faces 12.

In a preferred process, one array of optical fibers are laser cleaved at a time, and the optical fibers 16 are positioned into the multi-fiber ferrule 10 so they are positioned relative to the end face 12. The optical fibers 16 are preferably positioned so they protrude approximately 0-20 microns from the end face 12 and epoxied into place. The epoxy used to secure the optical fibers 16 in place is a light-curable epoxy. The translucent polymer used for the multi-fiber ferrule 10 allows for the epoxy to be cure in all locations of the multi-fiber ferrule 10. The use of a light-curable epoxy allows for the epoxy to be cured quickly, before the epoxy has time to wick to the ferrule end face 12.

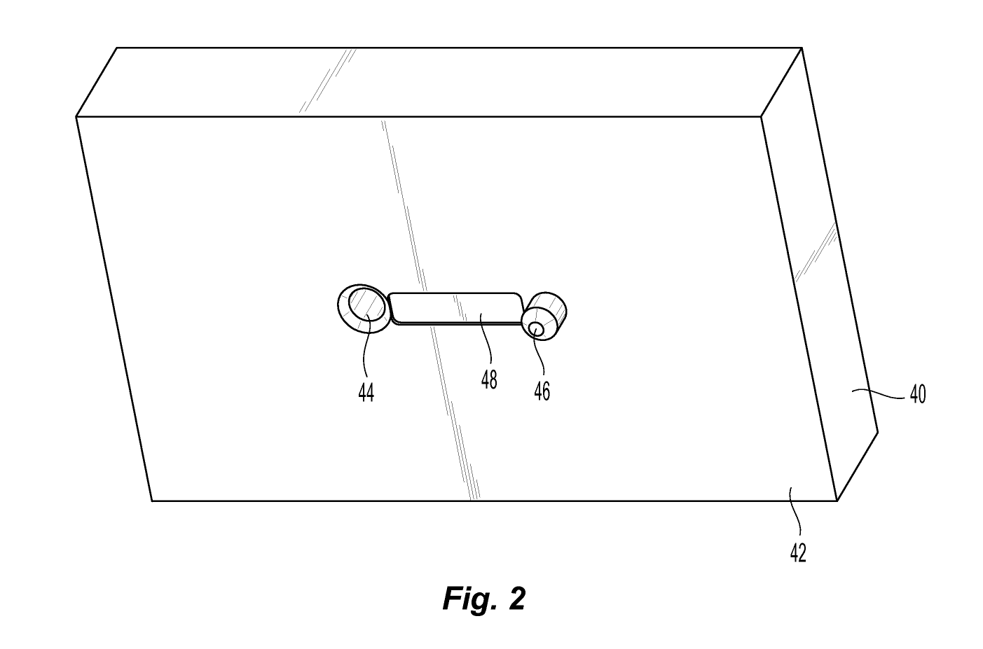

Illustrated in FIG. 2 is a plate 40 that assists in positioning the optical fibers 16 relative to the end face 12 and the molded guide pin 22 and molded opening 24. The plate 40 has a front face 42 that is positioned against the end face 16 of the multi-fiber ferrule 10. The plate 40 has a depression or opening 44 that corresponds to the molded guide pin 22 and a guide pin 46 that corresponds to the molded opening 24. Positioned therebetween is a depression 48 that is between 0 and 20 microns deep, depending on the amount of protrusion of the optical fibers 16 that the user needs.

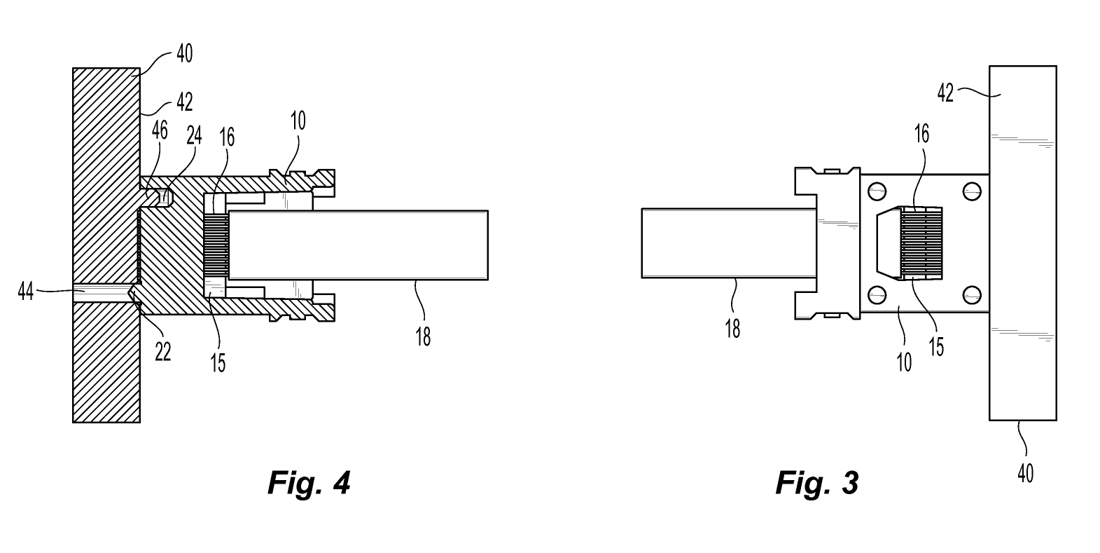

FIGS. 3 and 4 illustrate the plate 40 in use with the multi-fiber ferrule 10. As can be seen, the plate 40 is flush against the end face 16, the fibers are pushed through the multi-fiber ferrule 10 and end face 16 to engage the plate 40. In this position, the optical fibers 16 and optical fiber ribbon 18 are epoxied in place. Although the preferred embodiment consists of a plate with one hole and one guide pin, it is also possible to create a plate with either 2 guide pins or 2 holes that correspond to a ferrule with either 2 holes or 2 pins.

It should also be noted that the end face 16 of the multi-fiber ferrule 10 may also be polished, however, the polishing of the end face 16 may only be done on that portion of the end face 16 where the molded guide pin 22 is not located.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A multi-fiber ferrule comprising:
a main body having a front face and a middle portion;
a plurality of openings extending between the front face and the middle portion of the main body to receive optical fibers therein;
a fiber optic guide pin integrally formed with the main body and extending outwardly from the front face; and
a fiber optic guide pin opening extending through the front face and rearwardly to receive a corresponding fiber optic guide pin.

2. The multi-fiber ferrule according to claim 1, wherein the plurality of openings are disposed between the fiber optic guide pin and the fiber optic guide pin opening.

3. The multi-fiber ferrule according to claim 1, wherein the plurality of openings comprise at least twelve openings in a single row.

4. The multi-fiber ferrule according to claim 1, wherein the multi-fiber ferrule is made from a translucent material.

5. The multi-fiber ferrule according to claim 1, wherein a light-curable epoxy is used with the multi-fiber ferrule.

6. The multi-fiber ferrule according to claim 1, further comprising a recessed portion around the fiber optic guide pin.

7. A method of inserting optical fibers into a multi-fiber ferrule, the multi-fiber ferrule including a main body having a front face and a middle portion, a plurality of openings extending between the front face and the middle portion of the main body to receive optical fibers therein, the method comprising:
providing a plate having a front face and a recessed portion generally corresponding to the plurality of openings;
aligning the multi-fiber ferrule with the plate such that the plurality of openings align with the recessed portion;
inserting an optical fiber in each of the plurality of openings in the multi-fiber ferrule;
pushing the optical fibers toward the plate until ends of the optical fibers touch the plate; and
securing the optical fibers in the multi-fiber ferrule.

8. The method of claim 7, wherein the step of inserting the optical fibers comes before the step of aligning.

9. The method of claim 7, wherein the plate has at least one fiber optic guide pin extending outwardly away from the front face of the plate and the multi-fiber ferrule has a fiber optic guide pin opening extending through the front face and rearwardly to receive a corresponding fiber optic guide pin.

10. The method of claim 7, wherein the multi-fiber ferrule has at least one fiber optic guide pin extending outwardly away from the front face and the plate has a fiber optic guide pin opening extending from the front face and toward the plate to receive a corresponding fiber optic guide pin.

11. A multi-fiber ferrule comprising:
a main body having a front face and a middle portion; and
a plurality of openings extending between the front face and the middle portion of the main body to receive optical fibers therein, wherein the main body is made from a translucent polymer material having a modulus less than 18 GPa.

12. The multi-fiber ferrule according to claim 11, wherein a light-curable epoxy is used with the multi-fiber ferrule.
